(19) United States
(12) Patent Application Publication
(10) Pub. No.: US 2007/0148468 A1
(43) Pub. Date: Jun. 28, 2007

(54) Pressure-sensitive adhesive sheet for exterior portion of vehicle

(75) Inventors: Atsuhiro Tanaka, Tokyo (JP); Hisayuki Takayama, Tokyo (JP)

Correspondence Address: POSZ LAW GROUP, PLC, 12040 SOUTH LAKES DRIVE, SUITE 101, RESTON, VA, 20191, US

(73) Assignee: LINTEC Corporation, Tokyo (JP)

(21) Appl. No.: 11/645,791

(22) Filed: Dec. 27, 2006

(30) Foreign Application Priority Data
Dec. 28, 2005 (JP) 2005-378541

(51) Int. Cl. B32B 9/04

(52) U.S. Cl. 428/411.1

(57) ABSTRACT

In a pressure-sensitive adhesive sheet for an exterior portion of a vehicle comprising a substrate and a pressure-sensitive adhesive layer, the substrate is made to have a storage modulus at 80° C. of not less than 3.0×10¹ MPa, and a storage modulus at 5 to 40° C. in a range of from 1.0×10² to 2.5×10³ MPa, whereby problems such as peeling and wrinkling that are prone to occur when subjected to dynamic load are prevented.

### BACKGROUND OF THE INVENTION

1. Field of the Invention

The present invention relates to a pressure-sensitive adhesive sheet used on an exterior portion of a vehicle prone to being subjected to dynamic load.

2. Description of the Related Art

In recent years, it has become common to use a pressure-sensitive adhesive sheet in which a pressure-sensitive adhesive layer is laminated on a thermoplastic transparent film or colored film, or such a film having printing on a surface thereof, as a sheet as an alternative to paint on an exterior portion of a vehicle such as a passenger car, a bus, a train, or an airplane.

In the case that such a pressure-sensitive adhesive sheet is used on an automobile door sash, the pressure-sensitive adhesive sheet is subjected to dynamic load via a soft rubber glass run when the glass window is moved up and down, and hence problems have arisen such as the pressure-sensitive adhesive sheet wrinkling or peeling off at a portion subjected to the load.

Moreover, a pressure-sensitive adhesive sheet stuck onto an exterior portion of a vehicle is subjected to dynamic load due to wind pressure and collisions with rain, foreign matter and so on when the vehicle is moving at high speed, and hence there are problems such as the pressure-sensitive adhesive sheet peeling off from an edge thereof, or wrinkling in places.

To counteract these problems, there have been proposed, for example, an invention in which friction between a substrate surface and a glass run is reduced so as to avoid concentration of the dynamic load (Japanese Patent Application Laid-open No. 2001-288426, Japanese Patent Application Laid-open No. 2001-288427), and an invention in which the adhesiveness to an adherend is increased so as to prevent peeling off of the pressure-sensitive adhesive sheet (Japanese Patent Application Laid-open No. 7-3236).

However, with the above inventions, the effects of preventing peeling and wrinkling of the pressure-sensitive adhesive sheet are not sufficient, and in particular it has not been possible to prevent problems such as peeling and wrinkling of the pressure-sensitive adhesive sheet that occur frequently in summertime (in high temperatures).

### SUMMARY OF THE INVENTION

The present invention has been devised in view of the above state of affairs; it is an object of the present invention to provide a vehicle exterior portion pressure-sensitive adhesive sheet according to which problems such as peeling and wrinkling that are prone to occur when subjected to dynamic load can be prevented.

To attain the above object, the present invention provides a pressure-sensitive adhesive sheet for an exterior portion of a vehicle that comprises a substrate and a pressure-sensitive adhesive layer and is stuck onto an exterior portion of a vehicle, where in the substrate has a storage modulus at 80° C. of not less than 3.0×10¹ MPa (invention 1).

Note that in the present specification, “sheet” is deemed to include the idea of a film, and “film” is deemed to include the idea of a sheet.

According to the above invention (invention 1), the substrate is not prone to deforming under external force, and hence even if the pressure-sensitive adhesive sheet is subjected to dynamic load after having been stuck onto an exterior portion of a vehicle, peeling off of the pressure-sensitive adhesive sheet and wrinkling of the pressure-sensitive adhesive sheet can be prevented. In particular, because the storage modulus is stipulated at 80° C., problems such as peeling off or wrinkling of the pressure-sensitive adhesive sheet can be prevented from occurring even in the case that the pressure-sensitive adhesive sheet is subjected to dynamic load under a high temperature of approximately 80° C.

In the case of the above invention (invention 1), the substrate preferably has a storage modulus at 5 to 40° C. in a range of from 1.0×10² to 2.5×10³ MPa (invention 2). Through the substrate having such a storage modulus, the pressure-sensitive adhesive sheet has particularly good sticking ability under a temperature when stuck on under ordinary conditions.

In the case of the above inventions (inventions 1 and 2), the substrate preferably includes at least one coating layer positioned on one surface or both surfaces of the substrate (invention 3). Through the substrate including at least one such coating layer, the substrate can be made decorative or given any of various technical properties.

In the case of the above inventions (inventions 1 to 3), the exterior portion of the vehicle may be an automobile door sash (invention 4). In the case that the adherend is an automobile door sash, the effects of the pressure-sensitive adhesive sheet for the exterior portion of the vehicle of the present invention are particularly remarkable.

According to the pressure-sensitive adhesive sheet for the exterior portion of the vehicle of the present invention, problems such as peeling and wrinkling can be prevented effectively even when subjected to dynamic load.

### BRIEF DESCRIPTION OF THE DRAWINGS

FIG. 1 is a sectional view of a pressure-sensitive adhesive sheet for an exterior portion of a vehicle according to an embodiment of the present invention;

FIG. 2 is a sectional view showing an example of usage of the pressure-sensitive adhesive sheet for the exterior portion of the vehicle; and

FIG. 3 is a side view of a pressure-sensitive adhesive sheet and an adherend showing a test method for an adhesiveness test.

### DESCRIPTION OF THE PREFERRED EMBODIMENTS

Following is a description of an embodiment of the present invention.

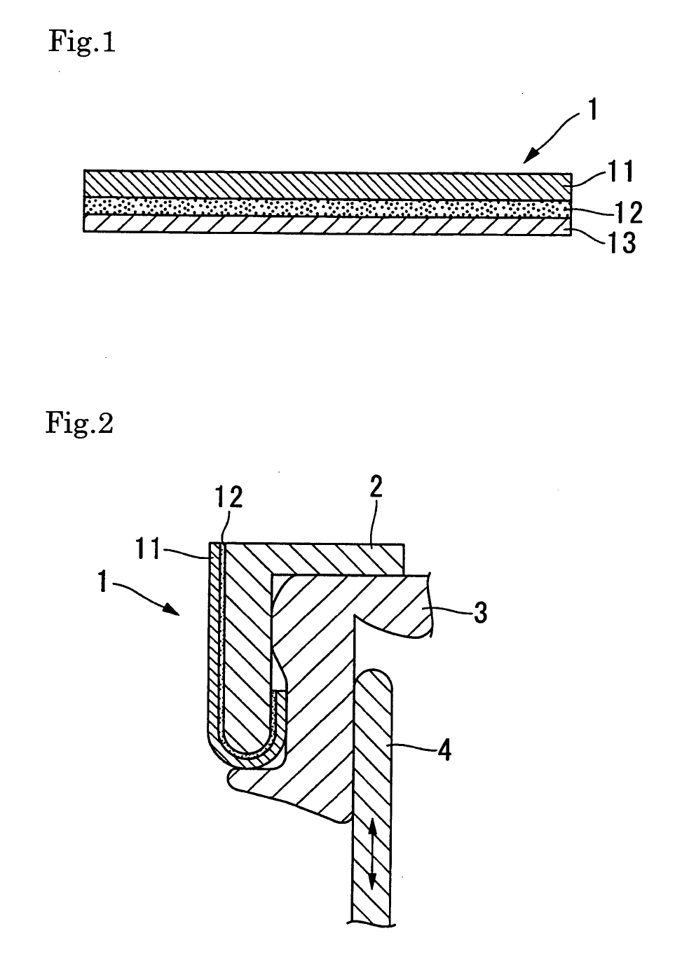

FIG. 1 is a sectional view of a pressure-sensitive adhesive sheet for an exterior portion of a vehicle according to an embodiment of the present invention.

As shown in FIG. 1, the pressure-sensitive adhesive sheet for an exterior portion of a vehicle 1 (hereinafter sometimes abbreviated to “pressure-sensitive adhesive sheet 1”) according to the present embodiment comprises a substrate 11, a pressure-sensitive adhesive layer 12, and a release liner 13 laminated on one another. Note, however, that the release liner 13 is peeled off when using the pressure-sensitive adhesive sheet 1.

The substrate 11 must have a storage modulus at 80° C. of not less than 3.0×10¹ MPa, preferably in a range of from 5.0×10¹ to 1.0×10⁴ MPa. Due to the substrate 11 having a such a storage modulus, the substrate 11 is not prone to deforming under external force, and hence even if the pressure-sensitive adhesive sheet 1 is subjected to dynamic load after having been stuck onto an exterior portion of a vehicle, peeling off of the pressure-sensitive adhesive sheet 1 and wrinkling of the pressure-sensitive adhesive sheet 1 can be prevented. In particular, for an exterior portion of a vehicle such as an automobile, the temperature may rise to approximately 80° C. in summertime, but because the storage modulus of the substrate 11 is stipulated at 80° C., problems such as peeling off or wrinkling of the pressure-sensitive adhesive sheet 1 can be prevented from occurring even in the case that the pressure-sensitive adhesive sheet 1 is subjected to dynamic load under such a high temperature.

Here, “dynamic load” means, for example, in the case that the pressure-sensitive adhesive sheet 1 is used on an automobile door sash, as shown in FIG. 2, dynamic load applied to the pressure-sensitive adhesive sheet 1 via a soft rubber glass run 3 when a glass window 4 is moved up and down, or in the case that the pressure-sensitive adhesive sheet 1 is used as a marking sheet or the like stuck onto an exterior portion of any of various vehicles, dynamic load due to wind pressure and collisions with rain, foreign matter and so on when the vehicle is moving.

Moreover, the substrate 11 preferably has a storage modulus at 5 to 40° C. in a range of from 1.0×10² to 2.5×10³ MPa, particularly preferably 1.2×10² to 2.3×10³ MPa. Through the substrate 11 having such a storage modulus, the substrate 11 exhibits a predetermined flexibility under a temperature when stuck on under ordinary conditions (5 to 40° C.), and hence the pressure-sensitive adhesive sheet 1 has particularly good sticking ability.

There are no particular limitations on the material of the substrate 11 so long as this material has a storage modulus as above; a resin film or a laminate having a resin film as a base substrate thereof is generally used.

As a resin film, there can be used, for example, a film or a foamed film made of a resin such as a polyolefin such as polyethylene or polypropylene, a polyester such as polyethylene terephthalate or polybutylene terephthalate, polyvinyl chloride, polystyrene, a polyurethane, a polycarbonate, a polyamide, a polyimide, polymethyl methacrylate, polybutene, polybutadiene, polymethylpentene, an ethylene-vinyl acetate copolymer, an ethylene-(meth)acrylic copolymer, an ethylene-(meth)acrylic ester copolymer, an ABS resin, or an ionomer resin, or a thermoplastic elastomer containing a component such as a polyolefin, a polyurethane, polystyrene, polyvinyl chloride or a polyester, or a laminated film of the above. The resin film may contain any of various additives such as inorganic fillers, organic fillers, and ultraviolet absorbers.

An example of a laminate having a resin film as a base substrate thereof is a resin film having at least one coating layer laminated on one surface or both surfaces thereof. Examples of a coating layer laminated on one surface of the resin film (a front surface of the substrate 11) include a colored or decorative layer formed by a method such as printing, painting, transfer printing, vapor deposition, or sputtering, an undercoat layer such as an adhesion facilitating coat for forming such a decorative layer, or a gloss adjusting coat, a topcoat layer such as a hard coat, an antifouling coat, a weather-proof coat, or a surface roughness or specular gloss adjusting coat, and an anti-static layer. Such a coating layer may be formed over the whole of the resin film, or may be formed on only part of the resin film.

Moreover, examples of a coating layer laminated on the other surface of the resin film (a surface of the substrate 11 that contacts the pressure-sensitive adhesive layer 12) include a primer layer for improving the adhesiveness to the pressure-sensitive adhesive layer 12, and an anti-static layer.

The thickness of each coating layer is generally from 0.1 to 50 μm, preferably approximately from 1 to 10 μm, but can be changed as appropriate in accordance with the type of the coating layer and the use of the pressure-sensitive adhesive sheet 1.

The thickness of the substrate 11 is generally from 10 to 400 μm, preferably approximately from 30 to 200 μm, but can be changed as appropriate in accordance with the material of the substrate 11 and the use of the pressure-sensitive adhesive sheet 1.

Examples of the type of a pressure-sensitive adhesive constituting the pressure-sensitive adhesive layer 12 include an acrylic type pressure-sensitive adhesive, a polyester type pressure-sensitive adhesive, a polyurethane type pressure-sensitive adhesive, a rubber type pressure-sensitive adhesive, and a silicone type pressure-sensitive adhesive; considering the adhesiveness to an exterior portion of a vehicle, an acrylic type pressure-sensitive adhesive is preferable, in particular an acrylic type pressure-sensitive adhesive containing acrylic acid. Moreover, the pressure-sensitive adhesive may be any of an emulsion type, a solvent type, or a solvent-less type, but in the case of an acrylic type pressure-sensitive adhesive, is preferably a solvent type.

The thickness of the pressure-sensitive adhesive layer 12 is generally from 1 to 300 μm, preferably approximately from 5 to 100 μm, but may be changed as appropriate in accordance with the use of the pressure-sensitive adhesive sheet 1.

There are no particular limitations on the material of the release liner 13; for example, a film or foamed film made of a resin such as polyethylene terephthalate, polypropylene or polyethylene, or paper such as glassine paper, coated paper or laminated paper that has been subjected to release treatment with a release agent such as a silicone type one, a fluorine type one or a long chain alkyl group-containing carbamate can be used.

The thickness of the release liner 13 is generally approximately from 10 to 250 μm, preferably approximately from 20 to 200 μm.

In the case of punching the pressure-sensitive adhesive sheet 1, it is preferable to use release paper of thickness from 130 to 200 μm obtained by subjecting polyethylene-laminated paper to release treatment with a silicone type release agent.

The production of the pressure-sensitive adhesive sheet 1 may be carried out using an ordinary method; for example, the pressure-sensitive adhesive layer 12 is formed on the release treated surface of the release liner 13, and then the substrate 11 is superposed onto the surface of the pressure-sensitive adhesive layer 12. The pressure-sensitive adhesive layer 12 can be formed by preparing a coating agent containing the pressure-sensitive adhesive that will constitute the pressure-sensitive adhesive layer 12, and also a solvent if desired, applying the coating agent onto the release treated surface of the release liner 13 using a coater such as a roll coater, a knife coater, a roll knife coater, an air knife coater, a die coater, a bar coater, a gravure coater, or a curtain coater, and drying.

The pressure-sensitive adhesive sheet 1 described above can be used, for example, as a pressure-sensitive adhesive sheet for an automobile door sash, or as a marking sheet stuck onto an exterior portion of a vehicle such as a passenger car, a bus, a train, or an airplane.

In the case that the pressure-sensitive adhesive sheet 1 is used as a pressure-sensitive adhesive sheet for a door sash, as shown in FIG. 2, the pressure-sensitive adhesive sheet 1 is stuck onto a surface of the door sash 2. The pressure-sensitive adhesive sheet 1 is in close contact with a soft rubber glass run 3 that is in contact with an edge of a glass window 4. When the glass window 4 is moved up and down, the pressure-sensitive adhesive sheet 1 is subjected via the glass run 3 to external force in the direction of movement of the glass window 4. However, because the substrate 11 of the pressure-sensitive adhesive sheet 1 has a storage modulus as described earlier and hence is not prone to deforming, peeling off of the pressure-sensitive adhesive sheet 1 from the door sash 2, and wrinkling of the pressure-sensitive adhesive sheet 1 can be prevented from occurring. This effect is exhibited well even under a high temperature of approximately 80° C. A similar effect is also obtained in the case that the pressure-sensitive adhesive sheet 1 is used as a marking sheet.

Note that the pressure-sensitive adhesive sheet 1 according to the present embodiment has the release liner 13, but there is no limitation to this in the present invention; the release liner 13 may be omitted. Furthermore, there are no particular limitations on the size, shape and so on of the pressure-sensitive adhesive sheet 1 according to the present embodiment. For example, the pressure-sensitive adhesive sheet 1 may be a tape comprising only the substrate 11 and the pressure-sensitive adhesive layer 12 (a pressure-sensitive adhesive tape), and may also be rolled up into a roll.

### EXAMPLES

Following is a more detailed description of the present invention through examples and so on; however, the scope of the present invention is not limited by these examples and so on.

### Example 1

A solvent type acrylic pressure-sensitive adhesive containing an acrylic acid as a monomer unit (made by LINTEC Corporation, SK) was applied using a knife coater such that the thickness after drying would be 40 μm onto the release treated surface of release paper (made by OJI PAPER CO., LTD., SP-12HL, thickness: 170 μm) obtained by subjecting polyethylene-laminated paper to release treatment with a silicone type release agent, and drying was carried out for 1 minute at 90° C. A 100 μm-thick polyurethane film (made by SEIKOH CHEMICALS CO., LTD., LUCKSKIN FT80-100BK14) as a substrate was superposed onto the pressure-sensitive adhesive layer thus formed, whereby a pressure-sensitive adhesive sheet was obtained.

### Example 2

A pressure-sensitive adhesive sheet was produced as in Example 1, except that the substrate used was one obtained by adding 5 parts by mass of a crosslinking agent (made by NIPPON POLYURETHANE INDUSTRY CO., LTD., Coronate HL, solid content 5 mass %) to 100 parts by mass of a polyurethane resin (made by SEIKOH CHEMICALS CO., LTD., LUCKSKIN U-7480, solid content 15 mass %) to obtain a coating liquid, applying the coating liquid using a bar coater such that the thickness after drying would be 1 μm onto the pressure-sensitive adhesive layer-contacting surface of a 100 μm-thick polyurethane film (made by SEIKOH CHEMICALS CO., LTD., LUCKSKIN FT80-100BK14), and drying for 5 minutes at 80° C. so as to form a primer layer, and the pressure-sensitive adhesive layer was superposed onto the primer layer surface of the substrate.

### Example 3

A pressure-sensitive adhesive sheet was produced as in Example 1, except that a polyolefin type resin laminated film (made by MITSHBISHI CHEMICAL MKV COMPANY, ARTPLY CT030, thickness: 100 μm) having a 2 μm-thick weather-proof colored coating layer on a surface thereof was used as the substrate, and the pressure-sensitive adhesive layer was superposed onto the surface of the substrate on the opposite side to the weather-proof colored coating layer.

### Comparative Example 1

A pressure-sensitive adhesive sheet was produced as in Example 1, except that a 100 μm-thick polyvinyl chloride film (made by KYOWA LEATHER CLOTH CO., LTD., KBO-G30-950100) was used as the substrate.

Test

For the substrate used in each of the Examples and the Comparative Example, the storage modulus was measured as follows. The results are shown in Table 1.

Measurement of storage modulus: The substrate was cut to 3 mm×30 mm, and the storage modulus was measured at 5° C., 40° C., and 80° C. at a frequency of 11 Hz using a dynamic viscoelasticity measuring apparatus (made by ORIENTEC CORPORATION, Rheovibron DDV-II-EP). Note that the heating rate was made to be 3° C./min.

Moreover, for the pressure-sensitive adhesive sheet obtained in each of the Examples and the Comparative Example, a wrinkling/peeling test and an adhesiveness test were carried out as follows. The results are shown in Table 1.

Wrinkling/peeling test: A test panel was prepared by coating a 25 mm×50 mm steel sheet with an acid rain-resistant paint comprising an acrylic resin containing silanol groups, epoxy groups and hydroxyl groups, and a metal chelate compound as a curing catalyst, and a piece of the pressure-sensitive adhesive sheet cut to a width of 20 mm and a length of 40 mm (with the release paper peeled off) was stuck onto the test panel by passing a 2 kg roller to and fro. Under an 80° C. atmosphere, an EPDM (ethylene propylene diene rubber) rubber piece of width 10 mm, length 20 mm, and height 5 mm was placed against the substrate surface of the pressure-sensitive adhesive sheet, and a 5 kg load was applied in a vertical direction from above the rubber piece such that the pressure-sensitive adhesive sheet would not move sideways. The test panel was then pulled in a horizontal direction with a 1 kg force, and after leaving for 24 hours, the pressure-sensitive adhesive sheet was inspected for changes in the appearance thereof.

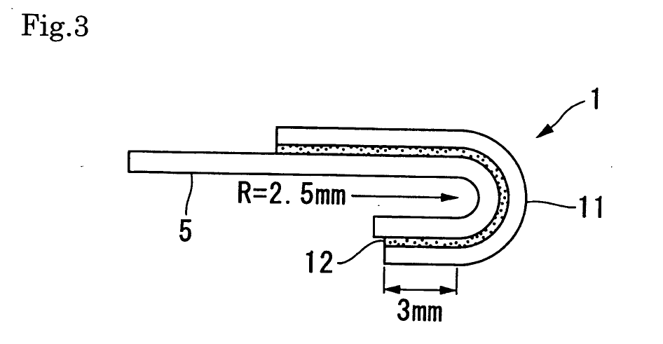

Adhesiveness test: A melamine coated plate of width 50 mm, length 150 mm, and thickness 0.2 mm was bent at an angle of 180 degree as shown in FIG. 3 such that R was 2.5 mm, and this was taken as an adherend 5. Under a 23° C., 50% RH environment, a piece of the pressure-sensitive adhesive sheet 1 cut to a width of 25 mm and a length of 50 mm (with the release paper peeled off) was stuck onto the adherend 5 by passing a 2 kg roller to and fro such that 3 mm of a straight portion was tucked down on a reverse side of the adherend 5 as shown in FIG. 3. It was checked whether or not there was any stretching of the pressure-sensitive adhesive sheet 1 immediately after the sticking, and it was checked whether or not there was any lifting away of the tucked in portion after 24 hours from the sticking.

TABLE 1

| | | | | Wrinkling/ | Adhesive- |
|---|---|---|---|---|---|
| | Storage modulus (MPa) | | | peeling | ness |
| | 80° C. | 5° C. | 40° C. | test | test |
| Example 1 | 9.0 × 10¹ | 3.3 × 10² | 1.9 × 10² | No | No |
| | | | | wrinkling/ | stretching/ |
| | | | | peeling | lifting |
| Example 2 | 9.0 × 10¹ | 3.3 × 10² | 1.9 × 10² | No | No |
| | | | | wrinkling/ | stretching/ |
| | | | | peeling | lifting |
| Example 3 | 1.3 × 10² | 8.9 × 10² | 4.1 × 10² | No | No |
| | | | | wrinkling/ | stretching/ |
| | | | | peeling | lifting |
| Comparative | 1.7 × 10¹ | 2.1 × 10³ | 5.6 × 10² | Wrinkling | No |
| Example 1 | | | | occurred | stretching/ |
| | | | | | lifting |

As can be seen from Table 1, for the pressure-sensitive adhesive sheet obtained in each of the Examples, the adhesiveness was good, and moreover even upon subjecting to dynamic load, there was no wrinkling or peeling.

### INDUSTRIAL APPLICABILITY

The pressure-sensitive adhesive sheet for the exterior portion of the vehicle of the present invention is suitable as, for example, a pressure-sensitive adhesive sheet for an automobile door sash prone to being subjected to dynamic load.

What is claimed is:

1. A pressure-sensitive adhesive sheet for an exterior portion of a vehicle that comprises a substrate and a pressure-sensitive adhesive layer and is stuck onto an exterior portion of a vehicle, wherein:
said substrate has a storage modulus at 80° C. of not less than 3.0×10¹ MPa.

2. The pressure-sensitive adhesive sheet for the exterior portion of the vehicle according to claim 1, wherein said substrate has a storage modulus at 5 to 40° C. in a range of from 1.0×10² to 2.5×10³ MPa.

3. The pressure-sensitive adhesive sheet for the exterior portion of the vehicle according to claim 1, wherein said substrate includes at least one coating layer positioned on one surface or both surfaces of said substrate.

4. The pressure-sensitive adhesive sheet for the exterior portion of the vehicle according to claim 1, wherein the exterior portion of the vehicle is an automobile door sash.
